(19) United States
(12) Patent Application Publication
(10) Pub. No.: US 2010/0043848 A1
(43) Pub. Date: Feb. 25, 2010

(54) DISHWASHER WITH A STORAGE CONTAINER WITH AN ALTERABLE SUPPORTING DISTANCE BETWEEN THE SUPPORTING MEANS

(75) Inventors: Hermann Moser, Altenmunster (DE); Bernd Schessl, Dillingen (DE); Rainer Schütz, Neresheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/513,883

(22) PCT Filed: Nov. 7, 2007
(86) PCT No.: PCT/EP2007/061970

§ 371 Date: May 7, 2009

(30) Foreign Application Priority Data
Nov. 10, 2006 (DE) 10 2006 053 075.6

(51) Int. Cl. B08B 3/00

(52) U.S. Cl. 134/137

(57) ABSTRACT

A dishwasher including a processing chamber and at least one rack-type storage container arranged in the processing chamber. The at least one rack-type storage container includes at least one holding device and supporting devices horizontally arranged on the at least one holding device. The supporting devices support items to be cleaned in the at least one holding device. The supporting devices have an alterable supporting distance.

The invention relates to a dishwasher according to the preamble of claim 1.

Dishwashers with a door and a washing container, which together define a processing chamber, are known from the prior art. A basket-type storage container for items to be cleaned is arranged in the processing chamber. A base wall and side walls of the storage container are embodied as carrying bars which form a basket-type grid. Holding bars are arranged in a perpendicular manner relative to the carrying bars of the base wall, which holding bars serve in storing the items to be cleaned. The carrying bars, in particular, which form the base wall of the storage container, are spaced at a constant distance from one another and cannot, in their supporting distance, be moved in either a longitudinal or a transverse direction.

A serious disadvantage of this solution, however, is that items to be cleaned, in particular plates, which have a smaller diameter than the supporting distance, fall out of the storage container through the carrying bars into the processing chamber of the dishwasher. The carrying bars of the base, which serve in securely storing the plates, are arranged in the region close to the side walls of the storage container such that plates, in particular plates having a larger diameter such as e.g. pasta plates, no longer lie on the carrying bars, but lie against a carrying bar on a side wall of the storage container. Due to the small supporting distance of the carrying bars from one another, the plates do not sink far enough into the base plane of the storage container. The consequence of this is that plates of a very large diameter no longer fit into the processing chamber of the dishwasher and knock against a top wall or possibly a second storage container which is arranged above the first storage container.

The object of the invention is therefore to provide in dishwashers of the type mentioned in the introduction a storage container for items to be cleaned, which storage container serves in the storage of items to be cleaned, in particular of plates, irrespective of their diameter.

The object of the invention is achieved in that the supporting means have an alterable supporting distance. This solution is characterized in particular in that, irrespective of the geometric shape of the items to be cleaned, in particular plates of a very large diameter and of a very small diameter are stored in the storage container. The possibility is ruled out that plates of a smaller diameter will fall out of the storage container into the processing chamber of the dishwasher. The solution also advantageously prevents plates of a large diameter from touching side walls and a top wall of the washing container. Consequently, plates of a very large diameter and of a very small diameter are now also stowed away securely in the storage container. This therefore ensures optimal use of space with regard to the height available since, irrespective of the diameter of the plates, these can be arranged in the storage container.

A preferred embodiment of the subject matter of the invention provides that the supporting distance is steplessly alterable. This solution offers the advantage that plates are arranged irrespective of diameter in the storage container.

An alternative preferred embodiment of the subject matter of the invention provides that the supporting distance is alterable in steps. This solution ensures a step is assigned to each diameter of plate, so that no fine adjustment of the supporting distance of the supporting means is needed.

An alternative preferred embodiment of the subject matter of the invention provides that the supporting means are designed as at least two opposing carrying bars of the storage container, which is embodied as a dish rack. This measure successfully achieves the outcome that the plates are securely arranged in the storage container during a wash process.

A further embodiment of the subject matter of the invention provides that the carrying bars are embodied as longitudinal bars or transverse bars of the dish rack, and the spacing between two transverse bars and/or two longitudinal bars is embodied in a variably adjustable manner. This arrangement ensures that the user has the choice of arranging the plates transversely or longitudinally in the dish rack. If the dish rack is already loaded with items to be cleaned, the user has the flexibility of arranging the plates transversely and/or longitudinally in the storage container.

The construction is very simple if, according to a preferred embodiment of the subject matter of the invention, it is provided that at least one transverse bar and/or a longitudinal bar of the dish rack is/are detachably mounted. This arrangement offers the advantage that the user can detach the horizontal bar and/or the longitudinal bar independently as required in order to alter the supporting distance. This solution is likewise characterized in that it is very user-friendly.

A further preferred embodiment of the subject matter of the invention provides that on the horizontal bar and/or longitudinal bar there is arranged at least one bar in an at least substantially perpendicular manner, which bar is pivotably mounted about a horizontal axis. By means of this arrangement, the user is able to alter the supporting distance very simply by pivoting the bar. Furthermore, the assembly can be implemented very cost-effectively.

A further preferred embodiment of the subject matter of the invention provides that the bar is embodied so as to be mechanically or electromechanically movable. The solution whereby the bar is embodied so as to be mechanically movable is characterized in particular in that it is very cost-effective to manufacture. If the bar is embodied so as to be electromechanically movable, then the moving of the bar is more user-friendly. In the case where the bar is moved mechanically, it should be stressed that the time spent on installation is reduced considerably as no electrical components are required.

A further preferred embodiment of the subject matter of the invention provides that the transverse bar and/or longitudinal bar is embodied so as to be displaceable in its transverse direction. The dishwasher according to the invention consequently has the advantage that the user organizes the loading of the items to be cleaned in a more flexible manner.

A further preferred embodiment of the subject matter of the invention provides that the transverse bars or longitudinal bars are arranged parallel to one another. This arrangement ensures that the items to be cleaned, in particular plates, are stored securely in the storage container during the wash process and that the plates are prevented from falling over, which could damage them.

A further preferred embodiment of the subject matter of the invention provides that on the transverse bars and/or longitudinal bars holding bars for fixing the items to be cleaned are arranged in an at least substantially perpendicular manner relative to the base plane. This solution is characterized in particular in that the holding bars provide in addition to the carrying bars for a stable and secure storage in the storage container of the items to be cleaned. This rules out the possibility that the items to be cleaned will fall over during the wash process and be damaged or even destroyed.

A further preferred embodiment of the subject matter of the invention provides that the plates are arranged contactlessly in relation to a side wall of the dish rack. This arrangement ensures that the items to be cleaned, in particular the plates, are wetted with cleaning fluid essentially from all sides.

A further preferred embodiment of the subject matter of the invention provides that a first storage container is arranged in the lower region of the washing container and a second storage container is arranged in the upper region of the washing container. Since the supporting distance of the supporting means is alterable, even plates of a very large diameter can be arranged in the storage container, as the plate can be lowered into the base plane of the storage container. In this case, a second storage container can be arranged in the dishwasher as adequate space is still available at the top if the plates have a large diameter. The user is therefore able to increase the quantity of items to be cleaned as he/she distributes these into the first storage container and/or the second storage container.

The invention also includes an inventive storage container.

The invention will be explained in the description below with the aid of an exemplary embodiment which is represented in a simplified manner in the drawings, in which:

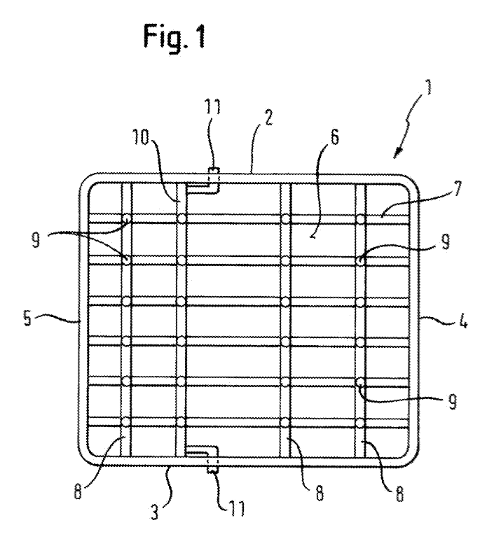

FIG. 1 shows a top view of a storage container according to a first embodiment comprising a supporting means, the supporting distance of which is steplessly alterable;

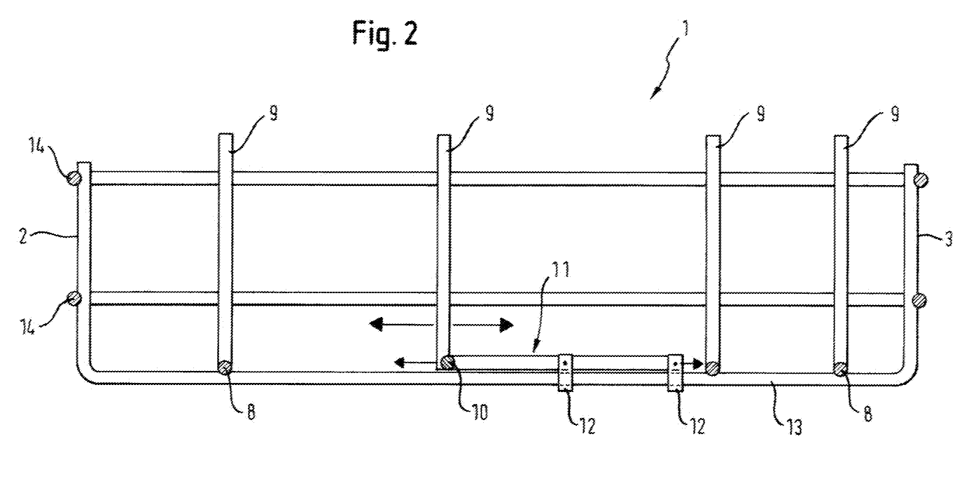

FIG. 2 shows a storage container, represented in a sectional side view, according to the first embodiment comprising the supporting means, the supporting distance of which is steplessly alterable;

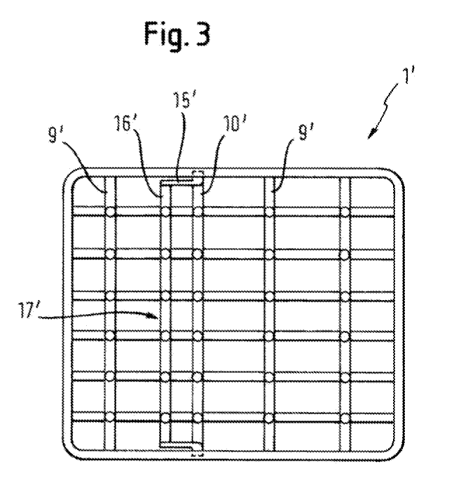

FIG. 3 shows a top view of a storage container according to a second embodiment comprising a supporting means, the supporting distance of which is alterable in steps;

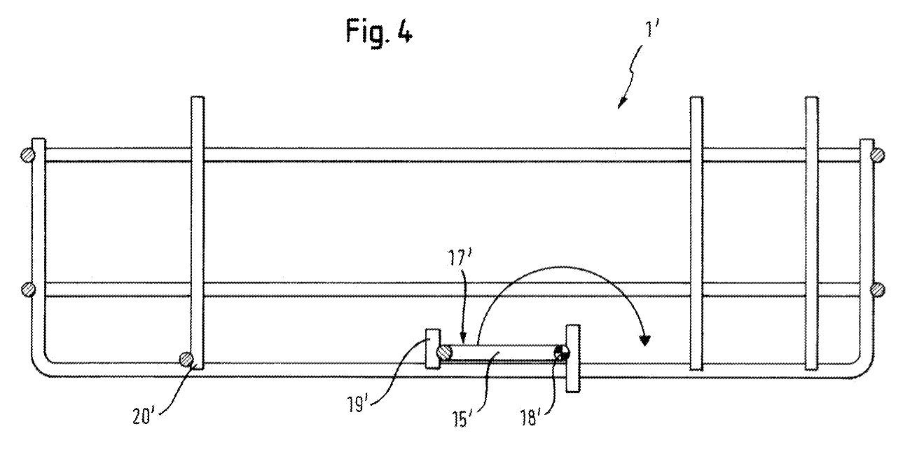

FIG. 4 shows a storage container, represented in a sectional side view, according to the second embodiment comprising the supporting means, the supporting distance of which is alterable in steps;

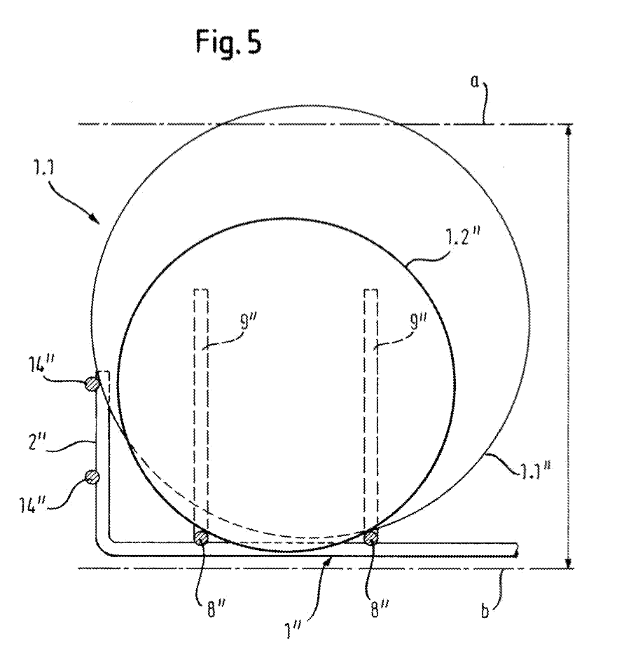

FIG. 5 shows in a side view a partial section through a storage container with a plate.

Shown in FIG. 1 is a first embodiment of a storage container 1 embodied as a dish rack for a dishwasher (not shown). The dishwasher has a washing container and a door, not shown in detail, which together enclose a processing chamber. Two storage containers 1 are arranged on top of one another inside the processing chamber. The upper storage container 1 and the lower storage container 1 are substantially identical in terms of construction. There are, however, also dishwashers, in particular table-top dishwashers, to which only a single storage container 1 is assigned.

The storage container 1 comprises a side wall 2, a side wall 3, a side wall 4 and a side wall 5, as well as a base 6, which have a rack-like structure. On the side wall 2 and on the side wall 3 of the storage container 1 is arranged a guide rail (not shown) which is non-detachably connected to the storage container. This guide rail is for moving the storage container 1 in and out of the processing chamber of the dishwasher. A storage container which is arranged in the lower region of the washing container could alternatively, instead of the guide rails, also have rollers for moving the storage container 1 in or out of the processing chamber of the dishwasher.

The base 6 of the storage container 1 has supporting means embodied as a holding device, which supporting means are embodied as carrying bars. The carrying bars are subdivided into longitudinal bars 7 and transverse bars 8. Arranged on the transverse bars 8 are holding devices 9 which are for storing the items to be cleaned stably and securely. Alternatively, the holding devices 9 could also be arranged on the longitudinal bars 7. A movable transverse bar 10 is embodied movably such that its spacing or its supporting distance relative to an adjacent transverse bar 8 is steplessly alterable by means of a displacement device 11. Alternatively, a plurality of transverse bars 8 could also be embodied as movable transverse bars 10 having a displacement device 11. It is also conceivable for a longitudinal bar 7 to be embodied so as to be movable and for a displacement device to be assigned to this longitudinal bar. A combination of movable longitudinal bars and movable transverse bars could increase the flexibility of the user when loading the items to be cleaned, in particular plates of a large or small diameter.

The supporting distance between the transverse bars 8 and the movable transverse bar 10 is embodied so as to be variably adjustable. The transverse bars 8 and the movable transverse bar 10 as well as the longitudinal bars 7 are detachably mounted and can be removed from the storage container 1 at any time. The holding bars 9 are essentially for fixing the items to be cleaned in place and are arranged in a substantially perpendicular manner relative to the base plane of the storage container.

Shown in detail in FIG. 2 is the displacement device 11 of the storage container 1. The displacement device 11 is arranged in a non-positive manner by means of two bolts 12 to a frame 13 of the base 6. The movable transverse bar 10 is displaced in its transverse direction by means of the displacement device 11 in order to alter the supporting distance between the movable transverse bar 10 and the adjacent transverse bars 8. The holding device 9 is arranged in a perpendicular manner relative to the base plane of the storage container 1 and in a perpendicular manner relative to the movable transverse bar 10, which holding device is for storing securely the items to be cleaned. In order to provide high safety and stable storage for the items to be cleaned, in particular for a plate, the plate has to lie against two holding devices.

In order to ensure stability of the entire storage container, the side walls 2, 3, 4, 5 are bounded by two closed bars 14.

Shown in FIG. 3 is a second embodiment of a storage container 1′. The storage container 1′ differs from the storage container 1 only in that the supporting distance of the supporting means is alterable in steps. Assigned to a transverse bar 10′ is a bar 15′ which is arranged so as to be essentially perpendicular to the transverse bar 10′ and parallel to a base plane of a washing container (not shown). The bar 15′ is connected to a foldable transverse bar 16′ and forms with this transverse bar a clamp 17′. This clamp 17′ is pivotably mounted about a horizontal axis 18′ (FIG. 4) such that the supporting distance between the foldable transverse bar 16′ and the transverse bars 9′ is alterable. The movement of the clamp 17′ in the present case is effected mechanically. Alternatively, however, the movement could be executed electromechanically by means of a motor.

FIG. 4 shows a sectional side view of the storage container 1′. The clamp 17′ is pivotably mounted about the horizontal axis 18′. A holding device 19′ is arranged on the bar 15′, which holding device is substantially shorter in length than the holding device 20′ because, when the clamp 17′ is folded down, the holding device 19′ must not protrude too far out of the base plane of the storage container 1. This is particularly important if a spray device (not shown) embodied as a spray arm is arranged below the storage container 1. If the holding device 19′ is too long, this holding device could prevent the spray arm from moving and cause a poor wash result. If, however, the spray device is embodied as a spray base which is an integral part of the storage container 1, then the holding bar 19′, for example, can be embodied of greater length as far as the base plane of the storage container. Alternatively, it is possible for the clamp 17′ to be subdivided into a plurality of smaller clamps which are pivotably mounted about a horizontal axis assigned to each respective clamp. The user can consequently decide himself/herself which sections are chosen for storing a plate 1.1 of a large diameter and in which section e.g. a saucer and such like of a small diameter can be stored. Altering the supporting distance of the supporting means also makes it possible for saucers and such like to be arranged in the storage container without protruding out of the base plane of the storage container 1 and preventing the spray device from spraying the cleaning fluid. If the saucers touch the spray device, the supporting distance of the supporting means is altered until such a point as the possibility of the saucers touching the spray device is ruled out.

In order to illustrate the storage of the plate 1.1 in the storage container 1 of the dishwasher according to the invention, FIG. 5 shows an inventive solution in greater detail. Shown in FIG. 5 is an upper boundary line a and a lower boundary line b. The upper boundary lines a and b represent the maximum height and depth available in the washing container without the plate 1.1 touching the washing container and/or the spray device. If the boundary lines a or b are exceeded, the plate 1.1 will bump against the washing container or the spray device, which is embodied as a spray arm, arranged in the storage container 1, which in an extreme case during operation is prevented from rotating on account of the plate 1.1. This will necessarily lead to a poor wash result.

A pasta plate embodied in the present case as a plate 1.1″ of an above-average diameter compared to a standard plate 1.2″, such as e.g. a dinner plate or a soup bowl, exceeds the boundary line a and consequently bumps necessarily against a spray arm (not shown in detail in FIG. 1a) and/or washing container. The plate 1.1″ is stored only by transverse bars 8″ arranged in the base plane of the storage container 1″. Furthermore, the plate 1.1″ touches a side wall 2″ of the storage container 1″, in particular one of two bars 14″ arranged on the side wall, which bars enclose the side wall 2′ and the side walls (not shown in detail) of the storage container 1″. This arrangement, however, gives rise to a fairly unstable storage of the plate 1.1″ in the storage container 1″. The standard plate 1.2″, on the other hand, touches in each case against a transverse bar 8″ and is thereby stored securely in the storage container 1.

The holding bars 9″ additionally arranged in the storage container 1″ are likewise for storing the plate. Due to the large diameter of the plate 1.1″, the possibility of two adjacent transverse bars 8″ touching the plate 1.1″ simultaneously is ruled out. Since the supporting distance between the adjacent transverse bars 8″ is unalterable, storage of the plate 1.1″ in the storage container 1″ inside the washing container is ruled out.

Furthermore, a displacement device 11 (not shown in FIG. 5) can be provided, which is for altering the supporting distance between the transverse bar 8 and the movable transverse bar 10.

As described previously, the supporting distance between two adjacent transverse bars 8 can be altered in an advantageous manner by means of an appropriate displacement device 11 (see FIG. 1 and FIG. 2) or a clamp 17′ (see FIG. 3 and FIG. 4). In this way, it is possible to arrange the plate 1.1 below the boundary line a and above the boundary line b in the storage container 1 without the plate 1.1 touching the washing container and the upper storage container (not shown) which can be arranged above the storage container 1.

The plate 1.1, in particular also the pasta plate, can now be stored in the storage container arranged in the washing container because the plate 1.1 can, if required, be lowered into the base plane as far as the boundary line b or as far as the spray device. The storage of the plate 1.1 in the storage container 1 is also more stable because the plate 1.1 in the solution according to the invention touches the transverse bar 8 and the movable transverse bar 10 and is held by both. The holding bars 9, which are arranged behind the plate 1.1, rule out the possibility of the plate 1.1 falling over. To store the plate 1.1, the bars 14 arranged on the side wall can be dispensed with, since the transverse bars 8,8′ and the holding bars 9 suffice fully for storing the plate 1.1 securely in the storage container 1. The bars 14 for storing the plate 1.1 mean that, for the plate 1.1 in the storage container 1, the storage system, comprising the transverse bar 8 and the movable transverse bar 10, is even statically over-specified.

1-14. (canceled)

15. A dishwasher comprising:
a processing chamber; and
at least one rack-type storage container arranged in the processing chamber,
wherein the at least one rack-type storage container includes:
at least one holding device; and
supporting devices horizontally arranged on the at least one holding device,
wherein the supporting devices support items to be cleaned in the at least one holding device, and
wherein the supporting devices have an alterable supporting distance.

16. The dishwasher as claimed in claim 15, wherein the alterable supporting distance is steplessly alterable.

17. The dishwasher as claimed in claim 15, wherein the alterable supporting distance is alterable in steps.

18. The dishwasher as claimed in claim 15, wherein the supporting devices include at least two opposing carrying bars of the at least one rack-type storage container, and
wherein the at least one rack-type storage container is a dish rack.

19. The dishwasher as claimed in claim 18, wherein the at least two opposing carrying bars include one of longitudinal bars and transverse bars of the at least one rack-type storage container, and
wherein a distance between two of the one of longitudinal bars and transverse bars is variably adjustable.

20. The dishwasher as claimed in claim 19, wherein at least one of the one of longitudinal bars and transverse bars of the at least one rack-type storage container is detachably mounted.

21. The dishwasher as claimed in claim 19, wherein the one of longitudinal bars and transverse bars includes:
at least one bar pivotably mounted about a horizontal axis,
wherein the at least one bar is substantially perpendicular to the horizontal axis.

22. The dishwasher as claimed in claim 21, wherein the at least one bar is one of mechanically and electromechanically movable.

23. The dishwasher as claimed in claim 19, wherein the one of longitudinal bars and transverse bars is displaceable in a transverse direction to the one of longitudinal bars and transverse bars.

24. The dishwasher as claimed in claim 19, wherein the one of longitudinal bars and transverse bars are arranged parallel to one another.

25. The dishwasher as claimed in claim 19, wherein the one of longitudinal bars and transverse bars include:
holding bars for fixing the items to be cleaned,
wherein the holding bars are arranged at least substantially perpendicular to a base plane.

26. The dishwasher as claimed in claim 15, wherein the items to be cleaned are arranged contactlessly relative to a side wall of the at least one rack-type storage container.

27. The dishwasher as claimed in claim 15, comprising:
a first storage container arranged in a lower region of the processing chamber; and
a second storage container arranged in an upper region of the processing chamber.

28. The dishwasher as claimed in claim 15, wherein the items to be cleaned are plates.

29. The dishwasher as claimed in claim 28, wherein the plates are arranged contactlessly relative to a side wall of the at least one rack-type storage container.

30. The storage container as claimed in claim 15.

31. A dishwasher comprising:
a processing chamber;
at least one rack-type storage container arranged in the processing chamber,
wherein the at least one rack-type storage container includes:
at least one holding device; and
supporting means for supporting items to be cleaned, the supporting means being horizontally arranged on the at least one holding device,
wherein the supporting means have an alterable supporting distance.

32. A rack-type storage container for a processing chamber of a dishwasher, the rack-type storage container comprising:
at least one holding device; and
supporting devices horizontally arranged on the at least one holding device,
wherein the supporting devices support items to be cleaned in the at least one holding device, and
wherein the supporting devices have an alterable supporting distance.
